(19) United States
(12) Patent Application Publication
(10) Pub. No.: US 2017/0331275 A1
(43) Pub. Date: Nov. 16, 2017

(54) REVERSE FAULT CURRENT INTERRUPTOR AND ELECTRICAL POWER SYSTEM EMPLOYING THE SAME

(71) Applicant: Bentek Corporation, San Jose, CA (US)

(72) Inventor: David WHITE, Denver, CO (US)

(21) Appl. No.: 15/481,997

(22) Filed: Apr. 7, 2017

Related U.S. Application Data
(60) Provisional application No. 62/336,481, filed on May 13, 2016.
(60) Provisional application No. 62/336,495, filed on May 13, 2016.

(51) Int. Cl. H02H 3/18; H01H 71/14; H01H 9/54; H01H 71/12; H02H 3/10; H01H 71/24

(52) U.S. Cl. CPC H02H 3/18; H02H 3/105; H01H 71/24; H01H 9/54; H01H 71/122; H01H 71/14

(57) ABSTRACT

A reverse fault current interruptor (RFCI) may be employed in one or more locations in an electrical power system. In one example, an RFCI may be installed in a combiner box of a solar power system. The RFCI may include a reverse current detector and a circuit protector such as a circuit breaker, operable in combination to clear a line-line fault in the combiner box. The RFCI enables a reduction of incident energy levels through detection of a reversal in a fault current characteristic of some DC power systems, where a traditional overcurrent protection device (OCPD) (e.g., fuse, breaker) may not trip in the same period of time.

### CROSS REFERENCE TO RELATED APPLICATION

This application claims the benefit of U.S. Provisional Application No. 62/336,481, filed on May 13, 2016, and U.S. Provisional Application No. 62/336,495, filed on May 13, 2016, the entire contents of both being incorporated herein by reference.

### BACKGROUND

Electrical power may be generated and distributed in the form of electricity from one or more power sources to end users, sometimes via a power distribution grid. For example, fossil fuel, nuclear, wind, or water power sources may be used generate and deliver electrical power to one or more end users directly or via a distribution system, which may distribute electricity via power lines constituting a grid to, e.g., residential or commercial end users. Solar or photovoltaic (PV) power may be used similarly to generate and distribute electricity. Solar-sourced electrical power commonly supplements power provided by other sources, although in some applications solar power is the sole source of electricity at the end use.

In a power system, the “balance of systems” (BOS) may comprise components used to modify, distribute, and ultimately deliver electricity generated from the energy source to the end user. For example, in a solar power system, the BOS may include such components as cabling, switches, enclosures, inverters, etc.

All electrical power systems are subject to electrical faults, both environmental (e.g., deteriorated insulation, animal intrusion) and human (e.g., mishandling of tools or protocol failures in installation or maintenance) in origin. Frequently, faults of this type are short circuits between positive and neutral conductors (“line-line” faults) or between positive and grounded conductors (“line-ground” or “ground” faults). Line-ground faults are known to present a risk of fire and damage to property in most types of electrical power systems.

Electrical faults may be divided into bolted faults and arc faults. A bolted fault may be a solid electrical fault path, an example of which is the tool that causes a short circuit. An arc fault may be an energy path between electrical conductors through air without a physical connection between them.

Arc faults may be classified as series or parallel arc faults. A series arc fault may be a high-resistance arcing connection that results from the failure of the intended continuity of the conducting path (wire, connector, terminals, etc.). A series arc fault may be accompanied by a luminous discharge of electrical energy, but may be limited in power to 100 W-5 kW in PV arrays, for example. A parallel arc fault may be an unintended connecting between line-line or line-ground that results in arcing. Parallel arc faults may have either high or low energy levels. In PV systems, low-energy faults may be more common, but in any electrical power transmission system, including medium voltage overhead lines, a parallel arc fault may result in a catastrophic release of energy and consequently lead to arc flash or arc blast.

Arc flash, generally speaking, is a discharge of electrical energy that results in the ionization of surrounding gas (e.g., air), thereby completing a circuit and allowing dangerous levels of incident energy to flow. “Incident energy” (e.g., the amount of energy generated during an arc event at a given distance from the source) is generally a quantitative measure of the severity of such a discharge, often measured in (kilo)calories per centimeter squared (cal/cm²). Arc flash may blind, burn, or kill any person standing nearby.

Arc blast, generally speaking, is an explosive blast caused by superheated air rapidly expanding as a result of an arc flash. Arc blast may cause deafness, as well as eject molten materials that may burn or impale a victim.

In some PV systems, one or more inverters are employed to convert DC current received from a combiner or directly from the PV solar panel(s) into AC current and fed to the power grid or for use by one or more off-grid loads. Such inverters may produce power on the order of kW to MW+. To achieve these high power levels, hundreds to thousands of PV source circuits, or “strings” are connected in parallel to each inverter. As a result, a high level of DC fault current is available on the input side of each inverter—comprising the available reverse fault current, or backfeed. All inverters may induce backfeed, or “reverse fault current”, after a fault. Reverse fault current may be a cause of system component damage and, in some circumstances, of electrical faults leading to arc flash and arc blast.

Standards and protocols exist to minimize the risk of dangerous reverse fault current, but the proliferation of non-load-break BOS components complicates field service and inspection of PV systems under load. Thus, even though overcurrent protection and personal protection equipment may be employed or even mandated, better protective measures should be implemented.

### SUMMARY

In at least one embodiment, a current interruptor comprises a reverse current detector operably coupled to an input conductor to: detect a reverse current resulting from an electrical fault in the input conductor, the reverse current being reverse to the direction of forward direct current in the input conductor, and in response to detecting the reverse current, to output a signal; and a circuit protector operably coupled to the reverse current detector to receive the signal and, in response to receiving the signal, to interrupt the reverse current in the input conductor.

In at least one embodiment, an electrical junction assembly comprises electrical circuitry configured to receive two or more direct current inputs of forward current via corresponding electrically parallel input conductors and to combine the two or more direct current inputs into one or more direct current outputs of forward current on corresponding output conductors, wherein the one or more direct current outputs are fewer in number than the two or more direct current inputs; and a reverse fault current interruptor operably coupled to the electrical circuitry and including: a reverse current detector operably coupled to at least one conductor of the input or output conductors to detect a reverse current resulting from an electrical fault, the reverse current being reverse to the direction of the forward direct current in the at least one conductor having the detected reverse current and, in response to detecting the reverse current, to output a signal; and a circuit protector operably coupled to the reverse current detector to receive the signal and, in response to receiving the signal, to interrupt the reverse current in the at least one conductor.

In at least one embodiment, a method of enhancing fault protection in an electrical power system having a source of electrical power; a system including cabling for transmitting electricity from the source to an electrical junction assembly configured with electrical circuitry to receive two or more direct current inputs of forward current via corresponding electrically parallel input conductors for combining into one or more direct current outputs of forward current on corresponding output conductors, wherein the one or more direct current outputs are fewer in number than the two or more direct current inputs; and a system for outputting electricity from the electrical junction assembly for downstream use; the method comprises installing a reverse fault current interruptor in the electrical junction assembly, the reverse fault current interruptor having a reverse current detector and a circuit protector, wherein installing the reverse fault current interruptor includes: operably coupling the reverse current detector to at least one conductor of the input or output conductors in a manner that enables the reverse current detector to detect a reverse current resulting from an electrical fault, the reverse current being reverse to the direction of the forward direct current in the at least one conductor having the detected reverse current and, in response to detecting the reverse current, to output a signal; and operably coupling a circuit protector to the reverse current detector in a manner that enables the circuit protector to receive the signal and, in response to receiving the signal, to interrupt the reverse current in the at least one conductor.

In accordance with the above and other embodiments, a reverse fault current interruptor enables a reduction of incident energy levels through detection of a reversal in a fault current characteristic of some DC power systems, where a traditional overcurrent protection device (e.g., fuse, breaker) may not open, or trip, in the same period of time.

### BRIEF DESCRIPTION OF THE DRAWINGS

The accompanying drawings are considered illustrative of inventive concepts described throughout the disclosure. To the extent that the drawings show inventive concepts, possibly including analysis that is properly considered to be inventive activity, the drawings nevertheless are illustrative in nature and should not be considered unduly limitative in any way.

FIG. 1 illustrates an example of a solar power system.

FIG. 2 illustrates an example of a reverse fault current interruptor.

FIG. 3 illustrates an example of a combiner simulation in a solar power system, including a reverse fault current interruptor.

FIG. 4 illustrates an example of a time-current curve characteristic of a PV circuit breaker having a thermal feature and a magnetic feature.

FIG. 5 illustrates a parametric sweep of fault current vs. time for a number of line-line faults of varying resistance when an instantaneous/magnetic trip setting is activated and when a reverse fault current interruptor would be activated.

FIG. 6 shows a table in which incident energy is associated with a hazard risk category that represents a level of risk or danger involved in high-energy electrical work at a given location.

### DETAILED DESCRIPTION

Embodiments are described herein that, for example, provide enhanced protection against electrical faults, and have notable applicability in power distribution systems of which solar power systems are an example. Improvements in safety, both for equipment and personnel, flow from the various embodiments. Other improvements and advantages also flow from the various embodiments, whether or not specifically disclosed. All such improvements and advantages are proper considered within the spirit and scope of the disclosed embodiments, without limitation.

Throughout the description, reference may be made to “electricity”, “current”, “electrical current”, “power”, “electrical power”, or the like. Although each of these terms are differentiable by one of ordinary skill in the art, for convenience, the terms are used substantially interchangeably except as noted.

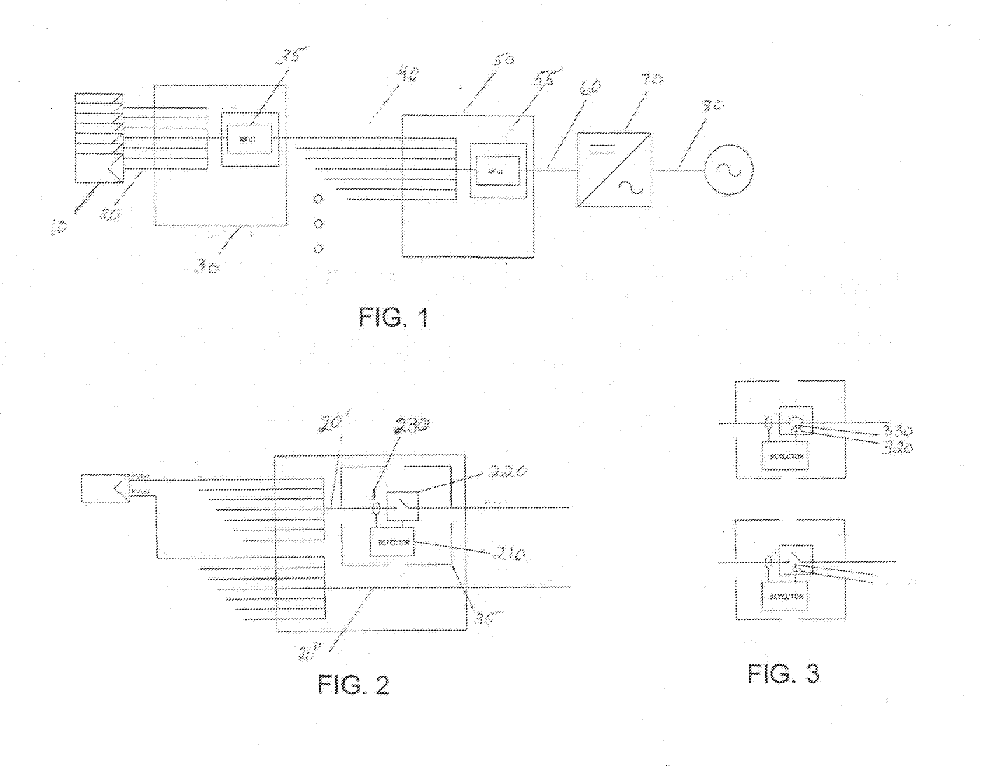

FIG. 1 illustrates an example of an electrical power system. In particular, a solar power system is shown as representative. Although a solar power system is illustrated, one of ordinary skill in the art will readily understand that other power systems utilizing similar components may have similar issues that may be addressed by the presently disclosed embodiments. For example, electrical power generated from fossil fuel or other energy sources may be distributed using similar components or concepts.

The solar power system represented by FIG. 1 may include, for example, a plurality of strings 10 each comprising one or more solar or photovoltaic (PV) panels (modules) in series. At least some of strings 10 may be arranged in electrical parallel. Each string 10 may output direct current power from the last module in the series via one or more conductors 20, which provide the direct current as an input to a combiner 30. In accordance with the parallel nature of strings 10, the direct current inputs to combiner 30 may be parallel inputs. In combiner 30, the direct current inputs are combined into one output via a conductor 40.

In some embodiments, one or more combiners 30 each may combine the direct current inputs into a plurality of outputs, the number of which is fewer than the number of inputs. The plurality of outputs in such embodiments may then be provided via conductors 40 as inputs to a recombiner 50, which may combine the inputs into one output provided via a conductor 60 as an input to an inverter 70. Inverter 70 may convert the DC input to alternating current (AC) for output via one or more conductors 80, e.g., to a residential user or to a power grid for further distribution.

In some embodiments, multiple combiners and recombiners may be arranged in a similar fashion as desired, for example depending on the scale of the power system. In such embodiments, the multiple combiners and recombiners may be stacked, with one or more inputs combined and recombined, respectively, as needed, ultimately providing the output as an input to inverter 70.

As shown in FIG. 1, a reverse fault current interruptor (RFCI) 35 may be provided in combiner 30. RFCI 35 may provide enhanced safety in the event of an electrical fault. For example, a short circuit between two conductors (a “line-line” fault) (not shown) within combiner 30 may induce a reverse current in one of the conductors. RFCI 35 may be configured to detect the reverse current and provide a remedy, as disclosed below.

Additionally or alternatively, an RFCI 55 may be provided in recombiner 50, as illustrated in FIG. 1.

In some embodiments, combiner 30 and/or recombiner 50 may be located inside an enclosure configured to be opened and closed. In such embodiments, combiner 30 may be termed a “combiner box” and recombiner 50 may be termed a “recombiner box”. In this description, “combiner” and “combiner box” (and “recombiner” and “recombiner box”) may be interchangeable as regards features of the disclosed embodiments. In a combiner box, at least the combiner circuitry, including the reverse fault current interruptor, may be housed in both of the opened and closed configurations, and likewise for a recombiner box.

FIG. 2 illustrates an example of RFCI 35 showing certain details. By way of nonlimiting example, RFCI 35 may include a reverse current detector 210 operably coupled to a circuit protector 220 and to a sensor 230, which is operably coupled to a PV source circuit ungrounded conductor 20′. (A PV source circuit grounded conductor 20″ is also shown.). Circuit protector 220 may include, for example, a circuit breaker having a thermal trip region and a magnetic trip region. The combination of reverse current detector 210 and circuit protector 220 may constitute a shunt trip switch by which reverse current detector 210, in response to detecting a reverse current in combiner 30 (for example, in accordance with a signal from sensor 230 sensing a reverse current fault in conductor 20′), provides a signal to circuit protector 220 in the form, e.g., of a magnetic pulse, whereby circuit protector 220 is opened or tripped. The signal may be provided in response to detecting a reverse current that exceeds a predetermined threshold or in response to detecting any reverse current. As indicated above, RFCI 35 may be configured to be attachable and detachable from its operable coupling to the at least one conductor in the enclosure.

FIG. 3 illustrates examples of RFCI 35 showing nonlimiting details of one or more circuit protectors 220 that may be suitable for use in the example illustrated in FIG. 2. Circuit protector 220 may include, without limitation, a circuit breaker (e.g., molded case circuit breaker, power circuit breaker), a switch (e.g., molded case switch, switch disconnector), or a disconnect (e.g., trippable disconnect, PV disconnect). The upper portion of FIG. 3 represents circuit protector 220 using a symbol for a circuit breaker, whereas the lower portion of FIG. 3 represents circuit protector 220 using a symbol for a switch.

Any of these circuit protectors may be coupled with an actuator such as a plunger and shunt trip coil or undervoltage release. A shunt trip coil 320, illustrated in both portions of FIG. 3, may include an electrical solenoid that actuates a mechanical plunger 330. An undervoltage release (not shown) may be configured with a coil so that, if electrical power is removed, the switch contacts will open.

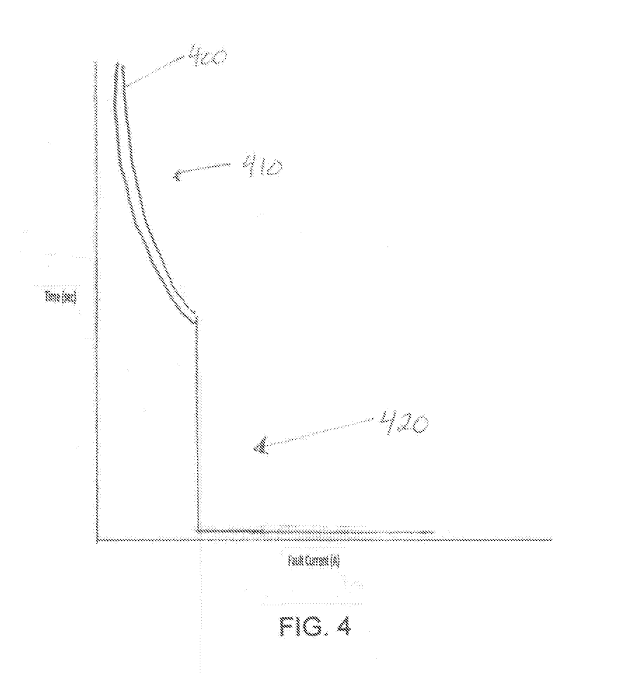

FIG. 4 illustrates an example of a time-current curve (or trip curve) 400 characteristic of a PV circuit breaker having a thermal feature and a magnetic feature (a “thermal magnetic” circuit breaker). The thermal feature may refer to a bimetal strip that operates to trip the breaker in response to the heat generated in a wire by, for example, a current overload (“overcurrent”). In general, the thermal trip mechanism may be activated by low levels of fault current, also known as “overload”—for example, 1-3× the breaker rating (in amps). The magnetic trip mechanism may respond quickly to fast, high-current overcurrent events (such as short circuits or faults). Any amount of current above a circuit's rating may also be referred to as “overcurrent.” The magnetic feature may refer to electromagnetic action by, e.g., a solenoid, that serves to open the breaker in response to a magnetic field induced by a short circuit, or large overcurrent event.

The trip curve 400 plots duration from time of fault to opening of the breaker vs. fault current as a multiple of the breaker's rated current. The upper left region 410 of trip curve 400 (the “thermal region” or “thermal response region”) may give the response time (relatively “long” in the 1000s of seconds, or “short” in the 100s of seconds) at which the breaker opens by operation of the bimetal strip. As shown by trip curve 400, the circuit breaker may open at relatively lower currents (e.g., 1-7×Iₙ, where Iₙ is the rated current of the circuit breaker) but only after a delay measurable in minutes.

The lower right region 420 of the curve (the “magnetic region” or “magnetic response region”) may give the circuit breaker's response to a relatively higher current (e.g., 7-10×Iₙ) that trips the breaker according to its electromagnetic action. A higher current is required to operate in the magnetic region but the response may be nearly instantaneous.

Considering electrical faults leading to arc flash, it is important to interrupt the circuit as quickly as possible. An electrical fault inducing a current sufficiently high to enter the magnetic region 420 may be cleared nearly instantaneously, possibly avoiding arc flash, and certainly reducing the amount of incident energy released, but the breaker's thermal response to lower currents may be insufficient in view of the potential for arc flash caused by an electrical fault wherein the device takes seconds to minutes to interrupt the fault.

RFCI 35 can be utilized to interrupt the circuit by the circuit protector's shunt trip feature at currents lower than would be ordinarily associated with a circuit breaker's magnetic trip region 420. Thus, in some embodiments, the predetermined threshold associated with reverse current detection and circuit breaker activation may be in the thermal response region of a circuit breaker (or fuse).

It should be noted that fuses and circuit breakers both may have regions that resemble those shown in FIG. 4 in that both may have periods associated with “long”, “short”, and/or “instantaneous” based on the amount of current going through them. A fuse may be different insofar that the trip curve may be determined by a single device—a strip of perforated metal that melts according to the trip curve—while a breaker may use a thermal trip mechanism in the long to short trip period (relatively lower overcurrent events) and the magnetic trip mechanism to cover the instantaneous region (relatively higher overcurrent events). As compared with breakers, systems employing fuses may be equally susceptible to gaps in protection at relatively lower levels of fault current. In such examples, an RFCI may be similarly applicable to reducing incident energy due to low-level reverse fault current whether a PV (electrical) system using fuses or breakers.

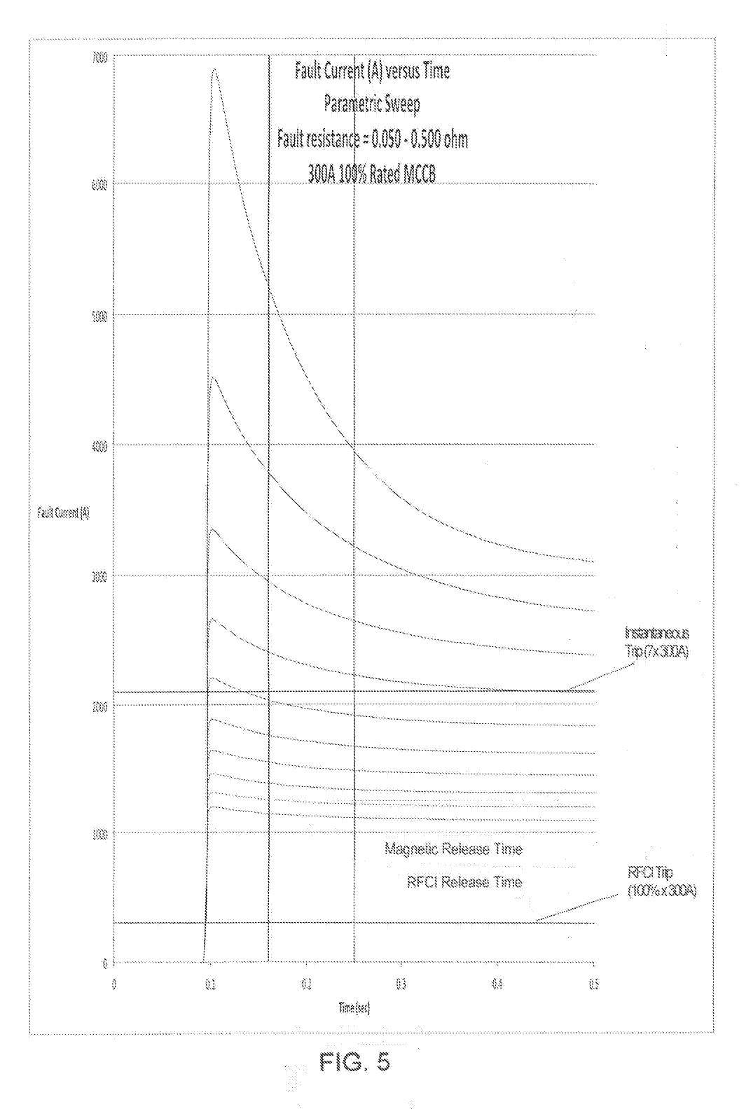

By way of nonlimiting example, FIG. 5 illustrates a parametric sweep of fault current vs. time for a number of line-line faults of varying resistance (0.050-0.500 ohm from top to bottom), when the instantaneous/magnetic trip setting is activated, and when the RFCI would be activated (trip setting=−1×circuit rated value) for the various faults. From the figure, one sees that values of fault resistance greater than 0.250 ohm would not reliably activate the instantaneous/magnetic trip function of a magnetic circuit protector absent the RFCI as disclosed (such as RFCI 35, 55), whereas with the disclosed RFCI, release circuit protector 220 is tripped for every fault resistance value from 0.050-0.500 ohm.

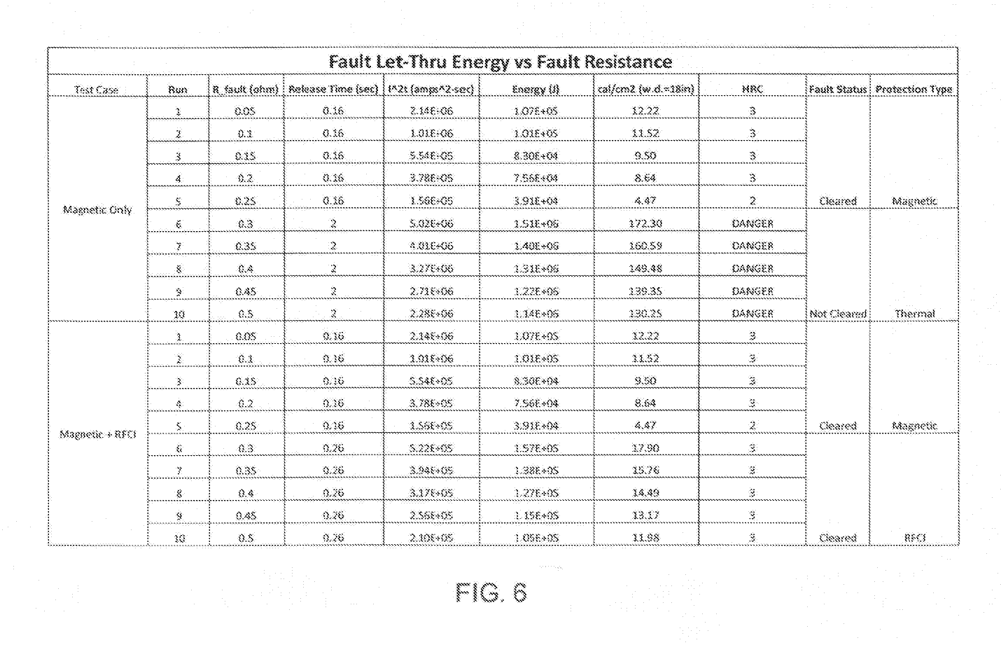

FIG. 6 compares a breaker-only condition versus breaker+RFCI to show another benefit of incident energy reduction that may be achieved by one or more embodiments during a fault occurrence. In the table of FIG. 6, incident energy is associated with a hazard risk category (HRC) that represents a level of risk or danger involved in high-energy electrical work at a given location in the PV array/electrical system and the protective wear for performing the work safely. For present purposes, an HRC above “3” may be considered unsafe for work while energized and is simply labeled as “DANGER” in the table.

FIG. 6 shows incident energy and the corresponding HRC for ten runs with a magnetic circuit breaker only and with a magnetic circuit breaker coupled with an RFCI as disclosed herein. Reference may be made to FIG. 5 as well. As shown in the table, with a magnetic breaker only, the HRC may be in the DANGER category (HRC>3 here), and personnel should not perform work in the subject environment without cutting power. Utilizing the RFCI may reduce incident energy by comparison. Correspondingly, the HRC may drop to 3 as shown, at which level the work can be performed without cutting power (and with appropriate protection). Thus, the table shows a measurable improvement in the level of incident energy and protection required for personnel.

RFCI 35 may be suitable for any size overcurrent protection device (OCPD) (e.g., one or more fuses, circuit breakers, etc.), mixed OCPD values, and/or low available fault currents. By clearing a fault nearly instantaneously, incident energy is reduced, reducing the possibility of associated arc flash. Personnel installing or performing maintenance on site (e.g., at combiner box terminals or near the inverter) are better protected accordingly and equipment damage can be reduced. Quick isolation of faults may also result in less lost energy and greater system availability.

Alternatively or in addition, an RFCI such as RFCI 35 and/or RFCI 55 need not necessarily be provided inside a combiner box or recombiner box. For example, an RFCI may be a standalone device, for example in a separate housing (its own or another) with its own sensor, detector, and/or circuit protector, with input and output terminals to be electrically coupled respectively to input and output conductors for, e.g., a single circuit to pass through. Components located in the housing need not be limited to the sensor, detector, circuit protector, or terminals. In one or more embodiments, the terminals may be configured to be readily connected and disconnected from the input and output conductors.

The present disclosure describes various examples of embodiments by which incident energy levels may be reduced with use of the RFCI. Among the benefits of reducing the incident energy level are reduction in the arc flash HRC, the ability of personnel to work at a given location in the PV array/electrical system that would otherwise require power shutdown, and the ability of such personnel to wear less personal protective equipment, thus allowing them to work more comfortably and unencumbered. Additionally, in the event of an accident, much less potentially lethal energy is let through.

Although various features, advantages, and improvements have been described in accordance with the embodiments shown, one of ordinary skill in the art will readily recognize variations and modifications to the embodiments as disclosed. All such variations and modifications that basically rely on the inventive concepts by which the art has been advanced are properly considered within the spirit and scope of the invention.

What is claimed is:

1. A current interruptor, comprising:
a reverse current detector operably coupled to an input conductor to:
detect a reverse current resulting from an electrical fault in the input conductor, the reverse current being reverse to the direction of forward direct current in the input conductor, and
in response to detecting the reverse current, to output a signal; and
a circuit protector operably coupled to the reverse current detector to receive the signal and, in response to receiving the signal, to interrupt the reverse current in the input conductor.

2. The current interruptor of claim 1, further comprising a housing in which the detector and circuit protector are located, wherein the housing is configured to receive the input conductor and an output conductor to be electrically coupled to the circuit protector.

3. The current interruptor of claim 2, further comprising:
an input terminal to be electrically coupled to the input conductor and the circuit protector; and
an output terminal to be electrically coupled to the circuit protector and the output conductor;
wherein the current interruptor is configured to be attachable and detachable from its electrical coupling to the input conductor and output conductor at the input terminal and output terminal, respectively.

4. The current interruptor of claim 1, wherein the current detector is configured to output the signal in response to detecting a reverse current exceeding a predetermined threshold for outputting the signal.

5. The current interruptor of claim 4,
wherein the circuit protector includes an overcurrent protection device; and
wherein the predetermined threshold is in the thermal response region of the overcurrent protection device.

6. The current interruptor of claim 5, wherein the overcurrent protection device includes a circuit breaker having a thermal trip feature and a magnetic trip feature.

7. The current interruptor of claim 6, further comprising:
a shunt trip switch configured to receive the signal from the detector and open the circuit protector to interrupt the reverse current.

8. An electrical junction assembly, comprising:
electrical circuitry configured to receive two or more direct current inputs of forward current via corresponding electrically parallel input conductors and to combine the two or more direct current inputs into one or more direct current outputs of forward current on corresponding output conductors, wherein the one or more direct current outputs are fewer in number than the two or more direct current inputs; and
a reverse fault current interruptor operably coupled to the electrical circuitry and including:
a reverse current detector operably coupled to at least one conductor of the input or output conductors to detect a reverse current resulting from an electrical fault, the reverse current being reverse to the direction of the forward direct current in the at least one conductor having the detected reverse current and, in response to detecting the reverse current, to output a signal; and
a circuit protector operably coupled to the reverse current detector to receive the signal and, in response to receiving the signal, to interrupt the reverse current in the at least one conductor.

9. The electrical junction assembly of claim 8, further comprising:
an electrical junction assembly enclosure configured to be opened and closed, in which the electrical circuitry and reverse fault current interruptor are housed in both of the opened and closed configurations.

10. The electrical junction assembly of claim 9, wherein the reverse fault current interruptor is configured to be attachable and detachable from its operable coupling to the at least one conductor in the enclosure.

11. The electrical junction assembly of claim 8, wherein the reverse current is induced by an electrical line-line fault shorting two of the input conductors.

12. The electrical junction assembly of claim 8, wherein the reverse current results from an electrical line-line fault in the at least one conductor.

13. The electrical junction assembly of claim 8, wherein the reverse current detector outputs the signal in response to detecting a reverse current exceeding a predetermined threshold for outputting the signal.

14. The electrical junction assembly of claim 13,
wherein the electrical circuitry includes an overcurrent protection device in series with one of the input conductors or output conductors; and
wherein the overcurrent protection device includes a fuse.

15. The electrical junction assembly of claim 13,
wherein the electrical circuitry includes an overcurrent protection device in series with one of the input conductors or output conductors; and
wherein the predetermined threshold is in the thermal response region of the overcurrent protection device.

16. The electrical junction assembly of claim 15, wherein the overcurrent protection device includes a circuit breaker having a thermal trip feature and a magnetic trip feature.

17. The electrical junction assembly of claim 16,
wherein the reverse fault current interruptor includes a shunt trip switch configured to receive the signal from the reverse current detector and open the circuit protector to interrupt the reverse current.

18. A method of enhancing fault protection in an electrical power system having a source of electrical power; a system including cabling for transmitting electricity from the source to an electrical junction assembly configured with electrical circuitry to receive two or more direct current inputs of forward current via corresponding electrically parallel input conductors for combining into one or more direct current outputs of forward current on corresponding output conductors, wherein the one or more direct current outputs are fewer in number than the two or more direct current inputs; and a system for outputting electricity from the electrical junction assembly for downstream use; the method comprising:
installing a reverse fault current interruptor in the electrical junction assembly, the reverse fault current interruptor having a reverse current detector and a circuit protector, wherein installing the reverse fault current interruptor includes:
operably coupling the reverse current detector to at least one conductor of the input or output conductors in a manner that enables the reverse current detector to detect a reverse current resulting from an electrical fault, the reverse current being reverse to the direction of the forward direct current in the at least one conductor having the detected reverse current and, in response to detecting the reverse current, to output a signal; and
operably coupling a circuit protector to the reverse current detector in a manner that enables the circuit protector to receive the signal and, in response to receiving the signal, to interrupt the reverse current in the at least one conductor.

19. The method of claim 18, wherein the installing of the reverse fault current interruptor in the electrical junction assembly is performed at a location at which the electrical junction assembly is deployed in the electrical power system.

20. The method claim 19, further comprising accessing the electrical junction assembly in an electrical junction enclosure that houses at least electrical connection points of the input conductors and output conductors and the reverse fault current interruptor within the electrical junction enclosure at the location of deployment in the electrical power system.
